(19) United States
(12) Patent Application Publication
(10) Pub. No.: US 2008/0043310 A1
(43) Pub. Date: Feb. 21, 2008

(54) VIBRATING MIRROR, LIGHT WRITING DEVICE, AND IMAGE FORMING APPARATUS

(76) Inventor: Yukito Sato, Miyagi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/838,392

(22) Filed: Aug. 14, 2007

(30) Foreign Application Priority Data
Aug. 14, 2006 (JP) 2006-221248
Jul. 25, 2007 (JP) 2007-193152

(51) Int. Cl. G02B 26/10; G02B 17/00

(52) U.S. Cl. 359/224

(57) ABSTRACT

A vibrating mirror is disclosed that is able to stably adjust a resonating frequency. The vibrating mirror includes a frame, a torsional beam, and a mirror substrate supported by the torsional beam and installed inside the frame. The mirror substrate is able to vibrate with the torsional beam as a center axis, and the frame, the torsional beam, and the mirror substrate are integrated together. Further, the vibrating mirror includes an elastic modulus adjustment unit arranged in the frame for adjusting an elastic modulus of the torsional beam.

### BACKGROUND OF THE INVENTION

1. Field of the Invention

The present invention relates to a vibrating mirror serving as a fine optical system to which a micro-machine technique is applied, and a light writing device (light scanning device) and an image forming apparatus, and in particular, to an image forming apparatus like a digital copier or a laser printer, a light writing device like a barcode reader or s scanner, and a vibrating mirror used in the light writing device and the image forming apparatus.

2. Description of the Related Art

For example, a vibrating mirror of a fine optical system utilizing a micro-machine technique is disclosed in “IBM J. Res. Develop Vol. 24 (1980)” (hereinafter, referred to as “reference 1”), in which a mirror substrate is supported by two beams located on the same straight line, and electrodes are arranged at positions facing the mirror substrate to vibrate the mirror substrate reciprocately with the two beams as a torsional rotation axis.

Compared to a light scanning device operated by rotation of a polygonal mirror employing a mirror in the related art, the vibrating mirror formed by using the micro-machine technique has a simple structure, and can be fabricated in a lump by semiconductor processes, hence, it is possible to make the device compact and reduce the cost; further, since there is only one reflecting surface, the problem of un-uniform precision of the plural surfaces of the polygonal mirror does not occur; moreover, it is anticipated that high operation speed is obtainable by the reciprocating scanning.

An electrostatic torsional vibrating mirror is disclosed in the related art, in which electrodes are provided at the end surfaces of the mirror substrate so that the electrode do not overlap in the vibrating region, thereby, increasing the vibrating angle of the mirror substrate.

“The 13th Annual International Workshop on MEMS2000 (2000) 473-478, MEMS 1999 (1999) pp 333-338” (hereinafter, referred to as “reference 2”) discloses a vibrating mirror driven by electrostatic force between a silicon movable electrode (serving as a mirror substrate) and an opposite fixed electrode disposed at the end surface of the mirror substrate with the opposite electrode apart from the movable electrode by a small gap, moreover, the two electrodes are formed at the same site.

In order to impose an initial moment with respect to the torsional rotation axis to initiate the mirror substrate, tiny structural asymmetry arising during the fabrication process is used in the vibrating mirror disclosed in reference 1, and in the vibrating mirror disclosed in reference 2, a metal electrode thin film is disposed on a surface perpendicular to the driving electrode to initiate the mirror substrate.

In order to increase the vibrating angle of the above vibrating mirrors, the driving frequency is adjusted to be in agreement with the resonating frequency of respective structures.

The resonating frequency f of a mirror can be expressed by the following formula (1)
f=½π(k/l)^{1/2} (1)

where, k represents the torsional elastic coefficient of a beam, and l represents the moment of inertia of the mirror.

The torsional elastic coefficient k can be expressed by the following formula (2),
k=βtc³E/L(1+σ) (2)

where, c represents the width of the beam, t represents the height of the beam, L represents the length of the beam, β represents the sectional form coefficient, E represents the Young's modulus, and σ represents the Poisson's ratio.

As shown by formula (1) and formula (2), the resonating frequency depends on the materials and shapes of the mirror substrate and the torsional beam, hence, the resonating frequency may have fluctuations depending on machinery precision.

In order to fine adjust the resonating frequency, Japanese Patent Gazette No. 2981600 (hereinafter referred to as “reference 3”) discloses a technique in which an element having a variable Young's modulus is provided on a torsional beam.

In addition, Japanese Laid-Open Patent Application No. 2003-84226 (hereinafter referred to as “reference 4”) discloses a light scanning device which includes a mirror substrate supported by two beams arranged on the same straight line and a mirror driving unit for reciprocately vibrating the mirror substrate with the beam as a torsional rotation axis, and in the light scanning device, a part of the mirror substrate is cut off to adjust the resonating frequency. Note that the invention disclosed in reference 4 is made by inventors of the present invention.

In the technique disclosed in reference 3, in which a Young's modulus variable element is provided on a torsional beam to fine adjust the resonating frequency, the Young's modulus variable element may be an electric resistance element or a piezoelectric element disposed on the surface of the torsional beam, and the heat produced during electric conduction of the electric resistance element heats the torsional beam, or deformation of the piezoelectric element imposes an internal stress on the torsional beam, thereby, the Young's modulus is changed.

The electric resistance element may include a metal film like Al or Pt, and the piezoelectric element may include a ceramic like BaTiO₃ or PZT. However, both the metal film and the ceramic are poly-crystal, and include crystal boundaries.

It is known that The torsional beam vibrates the mirror substrate by high-speed torsional deformation for a long term. Because the torsional beam and the mirror substrate are formed from single crystal silicon and are integrated together, the torsional beam and the mirror substrate are sufficiently durable even under the deformation.

On the other hand, since the metal film or the ceramic on the surface of the torsional beam is poly-crystal, the crystal boundaries may cause defects, and fatigue breakdown may cause burnout. In other words, when the Young's modulus variable element formed on the surface of the torsional beam is degraded, the adjustment precision of the resonating frequency lowers, and sometimes, this may cause failure of the resonating frequency adjustment.

### SUMMARY OF THE INVENTION

The present invention may solve one or more problems of the related art.

A preferred embodiment of the present invention may provide a vibrating mirror able to stably adjust a resonating frequency, and a light writing device and an image forming apparatus using the vibrating mirror.

According to a first aspect of the present invention, there is provided a vibrating mirror, comprising:

a frame;

a torsional beam;

a mirror substrate supported by the torsional beam and installed inside the frame so that the mirror substrate is able to vibrate with the torsional beam as a center axis; and

an elastic modulus adjustment unit that is arranged in the frame to adjust an elastic modulus of the torsional beam,

wherein

the frame, the torsional beam, and the mirror substrate are integrated together.

According to a second aspect of the present invention, there is provided a vibrating mirror, comprising:

the frame supports the torsional beam and is integrated with the torsional beam through a slit, and

the elastic modulus adjustment unit is able to change an internal stress in the frame.

As an embodiment, the elastic modulus adjustment unit is arranged to be symmetric with respect to the mirror substrate.

As an embodiment, a plurality of the elastic modulus adjustment units are arranged at positions symmetric with respect to the torsional beam.

As an embodiment, a plurality of the elastic modulus adjustment units are arranged at two or more positions symmetric with respect to a thickness direction of the mirror substrate.

As an embodiment, the mirror substrate, the torsional beam, the frame, and the elastic modulus adjustment unit are formed from silicon and are integrated together.

As an embodiment, the vibrating mirror further comprises:

a resonating frequency detection unit that controls the elastic modulus adjustment unit so that a resonating frequency is constant.

According to a third aspect of the present invention, there is provided a vibrating mirror, comprising:

a frame;

a torsional beam;

a mirror substrate supported by the torsional beam and installed inside the frame so that the mirror substrate is able to vibrate with the torsional beam as a center axis, the frame, the torsional beam, and said mirror substrate being integrated together;

an elastic modulus adjustment unit that is arranged in the frame to adjust an elastic modulus of the torsional beam,

a mirror driving unit that drives the mirror substrate;

a transmission part through which a light beam enters the mirror substrate; and

a terminal that is connected to the mirror substrate,

wherein

the mirror driving unit, the transmission part, and the terminal are accommodated in a decompression chamber.

As an embodiment, the elastic modulus adjustment unit comprises an adjustment structure, and

the adjustment structure is a Y-like shape, a square, or includes two squares placed side by side, or has an antenna shape.

According to a fourth aspect of the present invention, there may be provided a light writing device, comprising:

a vibrating mirror that includes
a frame,
a torsional beam,
a mirror substrate supported by the torsional beam and installed inside the frame, said mirror substrate being able to vibrate with the torsional beam as a center axis, and
an elastic modulus adjustment unit that is arranged in the frame to adjust an elastic modulus of the torsional beam, wherein the frame, the torsional beam, and the mirror substrate are integrated together;

a light source driving unit that modulates a light source according to an amplitude of the vibrating mirror; and

an image forming unit that condenses a light beam reflected from a mirror surface of the vibrating mirror to form an image on a scanning surface,

wherein

the vibrating mirror further comprises
a mirror driving unit that drives the mirror substrate;
a transmission part through which a light beam enters the mirror substrate; and
a terminal that is connected to the mirror substrate,

wherein the mirror driving unit, the transmission part, and the terminal are accommodated in a decompression chamber.

According to a fifth aspect of the present invention, there may be provided an image forming apparatus, comprising:

a vibrating mirror that includes
a frame,
a torsional beam,
a mirror substrate supported by the torsional beam and installed inside the frame, said mirror substrate being able to vibrate with the torsional beam as a center axis, and
an elastic modulus adjustment unit that is arranged in the frame to adjust an elastic modulus of the torsional beam, wherein the frame, the torsional beam, and the mirror substrate are integrated together;

an incidence unit that allows a light beam modulated according to a recording signal to be incident on a mirror surface of the vibrating mirror;

an imaging unit that condenses the light beam reflected from the mirror surface of the vibrating mirror to form an image;

an image supporter on which an electrostatic latent image is formed according to the recording signal;

a developing unit that develops the electrostatic latent image by toner; and

a transfer unit that transfers the toner image to a recording sheet,

wherein

the vibrating mirror further comprises
a mirror driving unit that drives the mirror substrate;
a transmission part through which a light beam enters the mirror substrate; and
a terminal that is connected to the mirror substrate,

wherein the mirror driving unit, the transmission part, and the terminal are accommodated in a decompression chamber.

According to the present invention, the vibrating mirror includes a mirror substrate supported by the torsional beam from two sides and installed inside the frame so that the mirror substrate is able to vibrate with the torsional beam as a center axis, and the elastic modulus adjustment unit is arranged in the frame for adjusting the elastic modulus of the torsional beam, and the frame, the torsional beam, and the mirror substrate are integrated together. Since the structure for adjusting the elastic modulus is outside the torsional beam, that is, in the decompression chamber, it is possible to stably adjust the resonating frequency without influence of the torsional vibration of the torsional beam.

In addition, according to the present invention, it is possible to change the internal stress of the structure with a small force, and it is possible to adjust the resonating frequency at low energy.

In addition, according to the present invention, since a stress force is imposed on the mirror substrate symmetrically, the optical axis of the mirror substrate does not shift, hence, it is possible to specify a wide adjustment range and realize high precision light scanning.

These and other objects, features, and advantages of the present invention will become more apparent from the following detailed description of preferred embodiments given with reference to the accompanying drawings.

### BRIEF DESCRIPTION OF THE DRAWINGS

FIG. 1A is a plan view illustrating a configuration of a vibrating mirror according to a first embodiment of the present invention;

FIG. 1B is a cross-sectional view of the vibrating mirror of the first embodiment along a line Ia-Ia in FIG. 1;

FIG. 1C is a plan view illustrating a configuration of a vibrating mirror of the first embodiment in which a piezoelectric element is used for driving the vibrating mirror;

FIG. 2A is a plan view of a portion of the vibrating mirror of the present embodiment including the adjustment structure 18;

FIG. 2B is a cross-sectional view of the vibrating mirror in FIG. 2A along the IIa-IIa line in FIG. 2A;

FIG. 3A through FIG. 3J are cross-sectional view of the vibrating mirror illustrating a method of fabricating the vibrating mirror of the present embodiment;

FIG. 4A through FIG. 4E are cross-sectional view of the vibrating mirror illustrating a method of fabricating an adjustment structure or an adjustment element of the vibrating mirror of the present embodiment;

FIG. 5 is a partial plan view illustrating a configuration of a vibrating mirror according to a second embodiment of the present invention;

FIG. 6 is a cross-sectional view illustrating a configuration of a vibrating mirror according to a third embodiment of the present invention;

FIG. 7 is a partial plan view illustrating a configuration of a vibrating mirror according to a fourth embodiment of the present invention;

FIG. 8A is an exploded perspective view of a vibrating mirror according to the fifth embodiment of the present invention;

FIG. 8B is a perspective view of the vibrating mirror according to the fifth embodiment of the present invention;

FIG. 9 is a schematic view of an image forming apparatus including a light write device according to a sixth embodiment of the present invention;

FIG. 10 is a partial plan view illustrating a configuration of a vibrating mirror according to a seventh embodiment of the present invention;

FIG. 11 is a partial plan view illustrating a configuration of a vibrating mirror according to an eighth embodiment of the present invention; and

FIG. 12 is a partial plan view illustrating a configuration of a vibrating mirror according to a ninth embodiment of the present invention.

### DESCRIPTION OF THE PREFERRED EMBODIMENTS

Below, preferred embodiments of the present invention are explained with reference to the accompanying drawings.

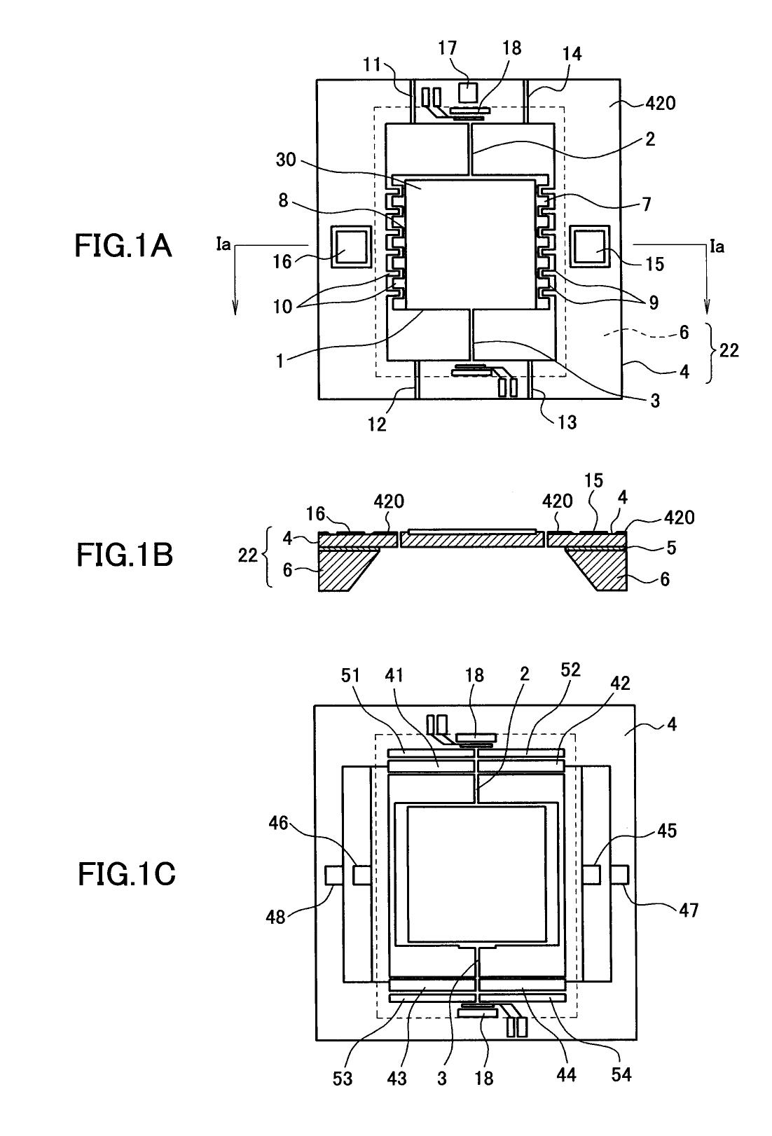

As described below with reference to the following drawings, particularly, FIG. 1A through FIG. 1C, a vibrating mirror of the present invention has a mirror substrate 1 reciprocately vibrated with torsional beams 2 and 3 as an axis to deflect a light beam from a light source; a frame 22 combines the mirror substrate 1 to the torsional beams 2, 3 to support the mirror substrate 1. The frame 22, the torsional beam 2, 3, and the mirror substrate 1 are formed on the same single board and are integrated together, thereby, forming the vibrating mirror of the present invention. Further, an elastic modulus adjustment structure 18 is arranged on the frame 22 supporting the torsional beams 2, 3 to adjust the elastic moduli of the torsional beams 2, 3. The frame 22 includes an upper frame 4 and a lower frame 6, which are bonded together to form the frame 22.

In the vibrating mirror of the present invention, the elastic modulus adjustment structure 18 for adjusting the elastic moduli of the torsional beams 2, 3 is integrated, through slits 11, 12, 13, 14, with portions of the upper frame 4 supporting the torsional beams 2, 3 The elastic modulus adjustment structure 18 includes adjustment elements for changing an internal stress of the upper frame 4.

The adjustment elements are arranged at positions symmetric with respect to the mirror substrate 1, and preferably, the adjustment elements are arranged at two or more positions symmetric with respect to the mirror substrate 1.

Further, the adjustment elements of the vibrating mirror are arranged at positions symmetric with respect to the torsional beams 2, 3, and preferably, the adjustment elements are arranged at two or more positions symmetric with respect to the torsional beams 2, 3.

The adjustment elements of the vibrating mirror are formed continuously from the elastic modulus adjustment structure 18 to the upper frame 4, and the mirror substrate 1, the torsional beams 2, 3, the frame, 22 and the elastic modulus adjustment structure 18 for adjusting the elastic moduli of the torsional beams 2, 3 are formed from silicon and are integrated together.

The vibrating mirror includes a resonating frequency detection unit for controlling the adjustment elements so that the resonating frequency of the vibrating mirror is constant. Further, the vibrating mirror and a mirror driving unit for driving the mirror substrate are accommodated in a decompression chamber (not-illustrated in FIG. 1A through FIG. 1C) which has a transmission part for a light beam deflected by the mirror substrate to pass through, and a terminal for connection to the mirror driving unit.

In addition, an image forming apparatus can be constructed by using the above vibrating mirror. For example, the image forming apparatus may include the above vibrating mirror, an incidence unit allowing a light beam modulated according to a recording signal to be incident on the mirror surface of the vibrating mirror, an imaging unit for condensing the light beam reflected by the mirror surface of the vibrating mirror to form an image, an image supporter on which an electrostatic latent image is formed according to the recording signal, a developing unit for developing the electrostatic latent image by toner, and a transfer unit for transferring the toner image to a recording sheet.

### First Embodiment

FIG. 1A is a plan view illustrating a configuration of a vibrating mirror according to a first embodiment of the present invention.

FIG. 1B is a cross-sectional view of the vibrating mirror of the first embodiment along a line Ia-Ia in FIG. 1.

FIG. 1C is a plan view illustrating a configuration of a vibrating mirror of the first embodiment in which a piezoelectric element is used for driving the vibrating mirror.

As shown in FIG. 1A and FIG. 1B, the vibrating mirror includes the mirror substrate 1, two torsional beams 2, 3, the adjustment structure 18, and the frame 22 with the upper frame 4 outside of the adjustment structure 18. The adjustment structure 18 is arranged on a joining portion of the upper frame 4 and the torsional beams 2, 3 (the joining portion is referred to as a “torsional beam supporting portion” below) so that the adjustment structure 18 is perpendicular to the torsional beams 2, 3. The mirror substrate 1, the torsional beams 2, 3, the adjustment structure 18, and the upper frame 4 have appropriate rigidity so that these components can be processed with high precision by fine processing, and are integrated together and are formed from single crystal silicon substrate having low electrical resistance so that these components can be directly used as electrodes.

The mirror substrate 1 is supported by the two torsional beams 2, 3 having the same axis at centers of two sides of the mirror substrate 1. On the mirror substrate 1, there is provided a thin metal film 30 which has sufficiently high reflectivity with respect to the light in use.

Dimensions of the mirror substrate 1 and the two torsional beams 2, 3 are designed so that the required resonating frequency can be obtained.

As shown in FIG. 1B, the frame 22 includes the upper frame 4 and the lower frame 6, which are bonded together with an insulating film 5 in between.

The thickness (height) of the lower frame 6 is designed appropriately so that the vibrating range of the mirror substrate 1 does not go beyond the space enclosed by the upper frame 4 and the lower frame 6, and there is no inconvenience when handling the vibrating mirror.

As shown in FIG. 1A, the two sides of the mirror substrate 1 not supported by the two torsional beams 2, 3 have interdigital shapes, in other words, the mirror substrate 1 has two interdigital shape side surfaces 7, 8 (also referred to as “movable electrodes” where necessary). On the other hand, at portions of the upper frame 4 corresponding to the interdigital shape side surfaces 7, 8, fixed interdigital-shape electrodes 9, 10 are formed which have the same shape with the interdigital shape side surfaces 7, 8, and are able to mesh with the interdigital shape side surfaces 7, 8. The fixed interdigital-shape electrodes 9, 10 are used for driving, and are formed with very small gaps between the fixed electrodes 9, 10 and the side surfaces 7, 8. A portion of the upper frame 4 having the fixed electrodes 9, 10 is electrically insulated, by the slits 11, 12, 13, and 14 formed in the upper frame 4, from the portion of the upper frame 4 joining to the torsional beams 2, 3.

As shown in FIG. 1A and FIG. 1B, an oxide film 420 is provided on the surface of the upper frame 4, and the fixed electrodes 9, 10 are formed on portions of the oxide film 420. The portions of the upper frame 4 having the fixed electrodes 9, 10 are electrically insulated from the portions of the upper frame 4 joining to the torsional beams 2, 3. Parts of the oxide film 420 are removed by etching to expose the underlying low-resistance silicon, and thin aluminum electrode pads 15, 16 (FIG. 1A) are formed, by sputtering, on the silicon-exposed portions by using masks. Furthermore, on the portion of the upper frame 4 joining to the torsional beams 2, 3, similarly, a part of the oxide film 420 is removed by etching to expose the underlying low-resistance silicon, and a thin aluminum electrode pad 17 (FIG. 1A) is formed, by sputtering, on the silicon-exposed part by using masks.

It should be noted that although it is described here the electrode pads 15, 16, 17 are formed from thin aluminum films by sputtering, as long as the electrode pads 15, 16, 17 have sufficient adhesiveness and electrical conduction with the silicon substrate, the electrode pads 15, 16, 17 can be formed by materials other than aluminum, such as platinum (Pt), and the electrode pads 15, 16, 17 can be formed by methods other than sputtering, such as vacuum evaporation, and ion-plating.

Further, in the present embodiment, it is assumed above that the vibrating mirror is configured to be driven by electrostatic force, but the vibrating mirror can also be configured to be driven by an electromagnetic force (namely, force induced when a current flows through a magnetic field), a piezoelectric element.

Below, the mirror structure shown in FIG. 1C is explained.

In FIG. 1C, the adjustment structure 18 is the same as that shown in FIG. 1A. As shown in FIG. 1C, at portions of the torsional beams 2, 3, driving beams 51, 52, 53, 54 are disposed to be perpendicular to the torsional beams 2, 3 and to face the upper frame 4. Piezoelectric elements 41, 42, 43, 44, each of which is sandwiched by electrodes at the top and the bottom, respectively, are disposed on the respective driving beams 51, 52, 53, 54. The electrodes at the bottoms of the piezoelectric elements 41, 42, 43, 44 are connected to the outside through electrode pads 45, 46 on the upper frame 4, and the electrodes at the tops of the piezoelectric elements 41, 42, 43, 44 are connected to the outside through electrode pads 47, 48 on the upper frame 4. Voltages are applied on the electrode pads 45, 46 and electrode pads 47, 48, alternately, thereby, providing the torsional beams 2, 3 with a driving torque to vibrate the mirror substrate 1 reciprocately.

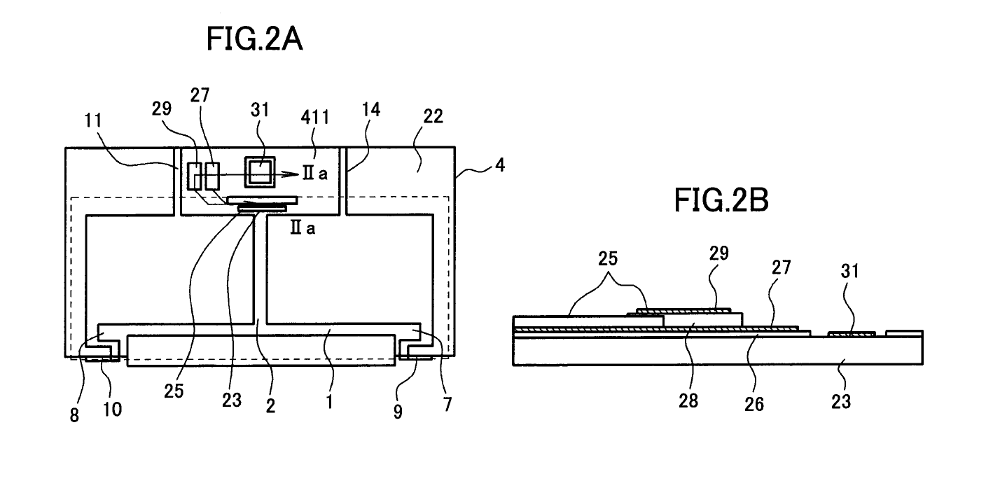

Below, the adjustment structure 18 of the vibrating mirror is described in detail with reference to FIG. 2A and FIG. 2B.

FIG. 2A is a plan view of a portion of the vibrating mirror of the present embodiment including the adjustment structure 18.

FIG. 2B is a cross-sectional view of the vibrating mirror in FIG. 2A along the IIa-IIa line in FIG. 2A.

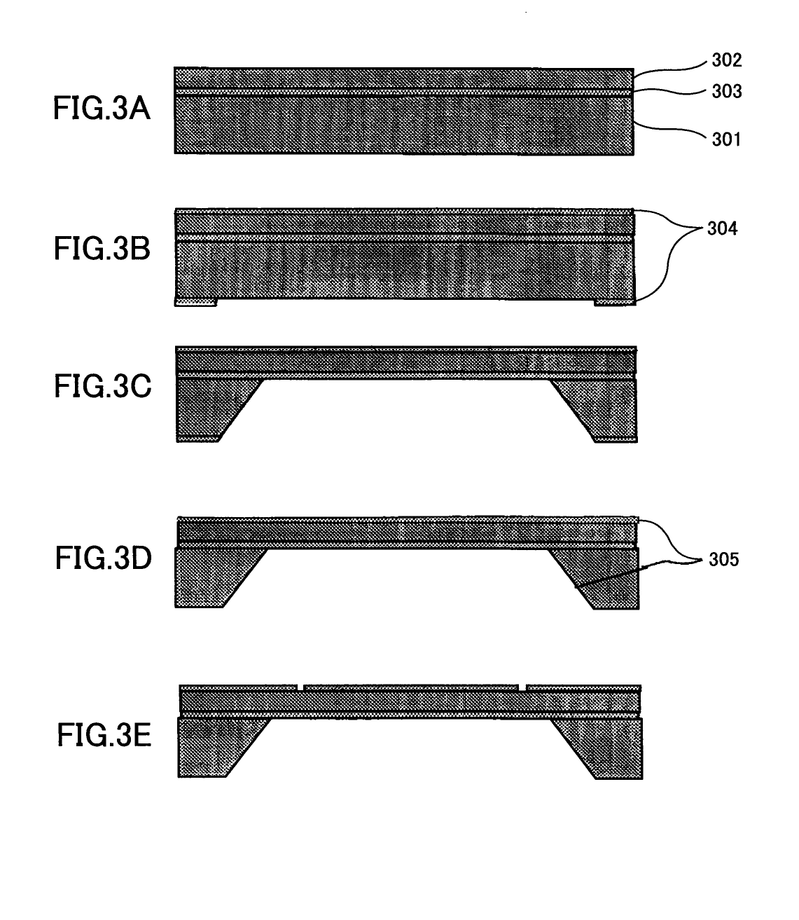

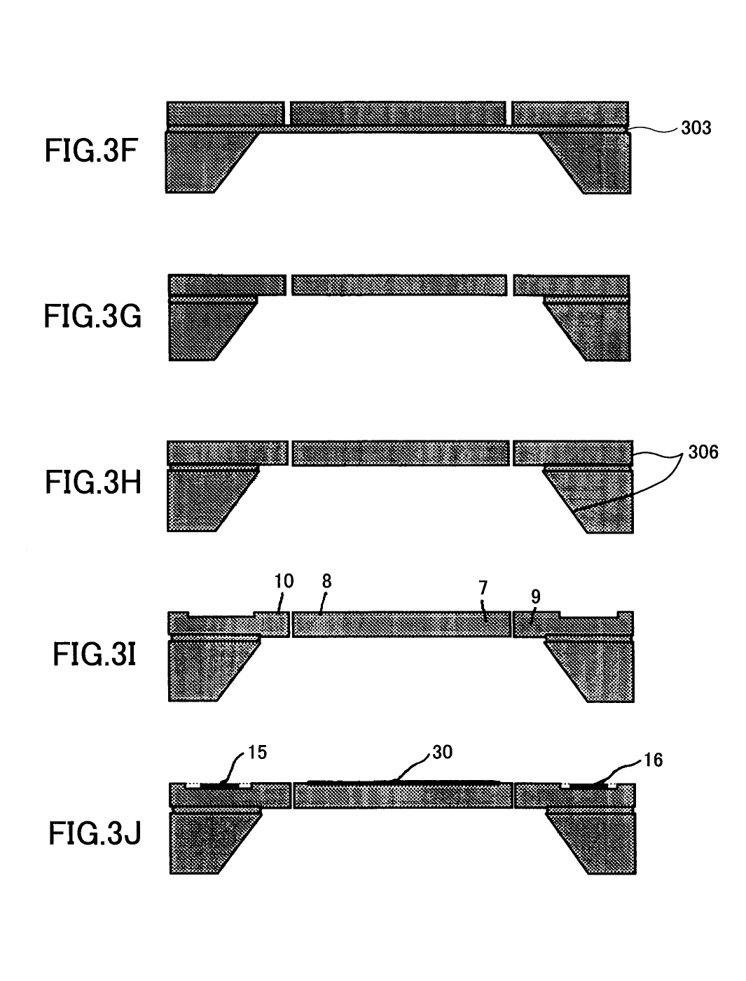

In FIG. 2A, the portion of the upper frame 4 joining to the torsional beam 2 (supporting the torsional beam 2) is indicated by a reference numeral 411. An adjustment structure 23 is formed on the portion 411 of the upper frame 4 integrally, by penetrating etching (refer to FIG. 3F and FIG. 3G below).

The adjustment structure 23 is formed by providing the slits 11, 14 in the portion 411 of the upper frame 4. The widths of the slits 11, 14 can be set to be any value as long as the required width of the adjustment structure 23 can be ensured. Further, preferably, the corners of the slits 11, 14 have curved shapes in order to prevent stress concentration.

The adjustment structure 23 is designed to have appropriate width and thickness so as not to be influenced by deformation occurring during vibration of the torsional beam 2. Further, an oxide film is formed on the surface of the adjustment structure 23 and the torsional beam 2, hence, the adjustment structure 23 is electrically insulated. A piezoelectric element 25 is arranged on the surface of the adjustment structure 23 along the long-side direction (horizontal direction in FIG. 2B) of the adjustment structure 23. It is preferable that the length of the piezoelectric element 25 in the horizontal direction be greater than the length of slits 11, 14.

An oxide film is deposited on the portion of the upper frame 4 continuing from the adjustment structure 23, and an electrode pad 27 and an electrode pad 29 are formed on the surface of the oxide film. The electrode pad 27 and the electrode pad 29 extend from the top surface and the bottom surface of the piezoelectric element 25 and are insulated by the oxide film. In addition, an electrode pad 31 is formed on a portion of the upper frame 4 with the oxide film being removed, in other words, the electrode pad 31 is formed directly on the silicon substrate of the upper frame 4.

Below, the electrode pad 27, the electrode pad 29, and the electrode pad 31 are explained in detail with reference to FIG. 2B.

An oxide film 26 is formed on the adjustment structure 23, and the electrode pad 31 is formed on a portion of the upper frame 4 where the oxide film 26 is removed, that is, the electrode pad 31 is formed directly on the silicon substrate of the upper frame 4. The electrode pad 31 is used for applying a voltage on the mirror substrate 1 via the adjustment structure 23 and the torsional beam 2.

The electrode pad 27 extending from the bottom surface of the piezoelectric element 25 is disposed on the surface of the oxide film 26. Further, an oxide film 28 is formed on the electrode pad 27, and the electrode pad 29 extending from the top surface of the piezoelectric element 25 is disposed on the surface of the oxide film 28.

When a voltage is applied on the electrode pad 27 and the electrode pad 29, the length of the piezoelectric element 25 changes along the direction parallel to the adjustment structure 23.

Below, operations of the vibrating mirror of the first embodiment is described with reference to FIG. 2A and FIG. 2B.

In order to ground the side surfaces 7, 8 of, which are on the sides of the mirror substrate 1 not supported by the torsional beams 2, 3 (that is, the movable electrodes 7, 8 of the mirror substrate 1) via the torsional beam 2, it is necessary to ground the electrode pad 31 first, which is formed on the portion 411 of the upper frame 4 following the torsional beam 2.

The portion 411 of the upper frame 4, the torsional beams 2, 3, and the mirror substrate 1 are formed integrally on the low-resistance silicon, hence, they are at the same potential.

When voltages are applied on the fixed electrodes 9, 10 from the electrode pads 15, 16 (FIG. 1A) formed on the portion 411 of the upper frame 4, an electrostatic force is induced between the fixed electrodes 9, 10 and the movable electrodes 7, 8, which face each other over the small gap, a small initial position shift occurs between the fixed electrodes 9, 10 in the thickness direction of the substrate, due to this, in order to reduce the distance between the fixed electrodes 9, 10 to a minimum, a rotational momentum is imposed on the mirror substrate 1, which is joined to the movable electrodes 7, 8, and this starts vibration of the mirror substrate 1.

In this way, vibration of the mirror substrate 1 is started and because of occurrence of resonating vibration, the vibrating angle of the mirror substrate 1 increases more and more.

It should be noted that although the operations of the vibrating substrate 1 are described above assuming that the resonating vibration of the vibrating substrate 1 is induced by an electrostatic force, the resonating vibration of the vibrating substrate 1 can also be induced by an electromagnetic force, or a piezoelectric element.

In this case, as described above, the resonating frequency is determined from the moment of inertia of the mirror substrate 1 (denoted to be 1), and the rigidity of the torsional beams 2, 3, namely, the resonating frequency is determined from the constituent materials and the shape of the mirror substrate 1. Due to this, depending on the processing precision, the desired resonating frequency cannot be obtained. In this case, if a voltage is applied on the electrode pad 27 and the electrode pad 29, which extend from the piezoelectric element 25, the piezoelectric element 25 tends to be deformed, accordingly, the internal stress of the adjustment structure 23 changes. When a compressive stress is imposed on the adjustment structure 23, a compressive stress is also imposed on the torsional beam 2, which is joined to the adjustment structure 23; when a tensile stress is imposed on the adjustment structure 23, a tensile stress is imposed on the torsional beam 2.

When a stress is imposed on the torsional beam 2, the torsional elastic coefficient k changes, and this induces a change of the resonating frequency f.

For example, assume the mirror substrate 1 has a size of 1 mm×4.5 mm, and the torsional beam 2 has a width of 0.08 mm and a length of 3.5 mm, and the mirror substrate 1 is supported by the torsional beam 2 and the resonating vibration of the mirror substrate 1 is induced. If the apparent elastic modulus of the torsional beam 2 is increased by 0.1% by an external stress, it is possible to shift the resonating frequency f by 1.6 Hz, and due to this, it is possible to correct the shift of the resonating frequency under usual temperature environment.

If the driving frequency is specified in advance, and the piezoelectric element 25 is controlled so that the vibrating angle becomes the maximum, which vibrating angle is detected by a light detection element for detecting scanning light beams from the vibrating mirror, or a deformation detection elements for detecting the deformation of the torsional beam 2, thereby, adjusting the resonating frequency f to be in agreement with the driving frequency.

Further, when the piezoelectric element 25 is used, it is possible to prevent decrease of the vibrating angle caused by a change of the environment temperature. Specifically, the displacement of the piezoelectric element 25 can be fed back to maintain the vibrating angle to be constant.

Below, a method of fabricating the vibrating mirror of the present embodiment is described with reference to FIG. 3A through FIG. 3J.

FIG. 3A through FIG. 3J are cross-sectional view of the vibrating mirror illustrating a method of fabricating the vibrating mirror of the present embodiment.

As shown in FIG. 3A, two silicon substrates 301, 302 each having a thickness of 525 μm are bonded with a thermal oxide film 303 having a thickness of 500 nm in between (This is referred to as “direct bonding”). Then, the silicon substrate 301 is polished and grounded to a thickness of 300 μm, and the silicon substrate 302 is polished and grounded to a thickness of 100 μm. The silicon substrate 301 is used as the lower frame 6, and the silicon substrate 302 is used as a substrate for forming the upper frame 4, the torsional beams 2, 3, and the mirror substrate 1.

Here, a low-resistance silicon substrate, for example, less than 0.1 Ωcm, is used for the silicon substrate 302 since the silicon substrate 302 also acts as an electrode.

The direct bonding is executed as below. One of the silicon substrate 301 and the silicon substrate 302 is oxidized by heating, then, the polished bonding surfaces of the mirror surfaces of the silicon substrate 301 and the silicon substrate 302 are thoroughly cleaned. Next, the silicon substrate 301 and the silicon substrate 302 are brought into contact in a clean and low-pressure atmosphere at a temperature of 500° C. for tentative bonding, and then, a thermal treatment is executed at 1100° C. to fully bond the silicon substrate 301 and the silicon substrate 302. The purpose of executing the tentative bonding in a low-pressure atmosphere is for preventing occurrence of voids on the bonding surfaces of the mirror surfaces of the silicon substrate 301 and the silicon substrate 302.

Next, as shown in FIG. 3B, silicon nitride (SiN) films 304 are formed on two the outer sides of the bonded silicon substrate 301 and the silicon substrate 302 by LP-CVD (Low Pressure Chemical Vapor Deposition) (a nitride film furnace) to a thickness of 300 nm, and the silicon nitride film 304 on the side of the silicon substrate 301 is removed by using a resist masks, thereby, forming a SiN mask pattern used for forming the lower frame 6.

Next, as shown in FIG. 3C, with the patterned silicon nitride (SiN) film 304 as an etching mask, and by using a 30 wt % KOH solution, anisotropic etching is performed on the silicon substrate 301 serving as a bonding surface until the thermal oxide film 303 is exposed, thereby, forming the lower frame 6. Here, for example, the silicon substrates have (100) orientation, due to this, the inner side of the lower frame 6 is formed to be inclined surfaces corresponding to a (111) plane at 54.7°. The position of the bottom surface of the inclined surfaces is formed to be on the outside of the interdigital electrodes of the upper frame 4 formed in subsequent steps, so that the bottom surface of the inclined surfaces is not influenced by the interdigital electrodes.

Next, as shown in FIG. 3D, the silicon nitride (SiN) film etching mask 304 is entirely removed by etching with a thermal phosphoric acid, and then, a thermal oxide film 305 having a thickness of 1 μm is formed on the silicon substrate.

Next, as shown in FIG. 3E, dry etching using an etching gas including CF₄ (carbon tetrafluoride) is performed on the thermal oxide film 305 formed on the side of the silicon substrate, which serves as a device substrate, to pattern the mirror substrate 1, the torsional beams, fixing members, and the upper frame, as shown in FIG. 1A. When forming the resist mask, double-side alignment device is used to align the position of the vibrating mirror device and the position of the lower frame 6.

Next, as shown in FIG. 3F, with the patterned oxide film 305 as an etching mask, high density plasma etching using a SF₆ (Sulfur Fluoride) etching gas is performed on the silicon substrate 302, which serves as a device substrate, to penetrate the silicon substrate 302 until the thermal oxide film 303 (a bonding surface) is exposed. In this step, on the side of the mirror substrate not joined to the torsional beams, the movable electrodes 7, 8 driven by the electrostatic force are processed to have an interdigital shape. Since the thermal oxide film 303 (a bonding surface) has a large etching selection ratio compared to silicon, the etching processing stops when the thermal oxide film 303 is reached. The mirror substrate 1 obtained by penetration separation through etching is supported by the torsional beams 2, 3 and the thermal oxide film 303 in the joint portion.

Next, as shown in FIG. 3G, the whole substrate is placed into a BHF (Buffered Hydrofluoric acid) etching solution to remove the thermal oxide film 303 supporting the mirror substrate 1, hence, the mirror substrate 1 is supported only by the torsional beams 2, 3.

Next, as shown in FIG. 3H, in order to prevent occurrence of short circuit during operations, a thermal oxide film 306 having a thickness of 1 μm is formed on the whole substrate including the interdigital electrodes 7, 8, 9, 10 (as shown in FIG. 1A), and the fixing members.

Next, as shown in FIG. 3I, a portion of the thermal oxide film 306, where the electrode pad 31 for the upper frame 4 is to be formed, is removed by mask etching.

Next, as shown in FIG. 3J, on the portion of the upper frame 4, where the thermal oxide film 306 is removed and the underlying low-resistance silicon is exposed, electrode pads 307, 308, which are used for applying voltages on the interdigital fixed electrode pads 7, 8, and 9, 10, and the fixing members of the torsional beams 2, 3, are formed by depositing a film (by sputtering) using a metal mask, and then a metal film 309 serving as a reflecting surface of the mirror substrate is also formed by depositing a film (by sputtering) using a metal mask.

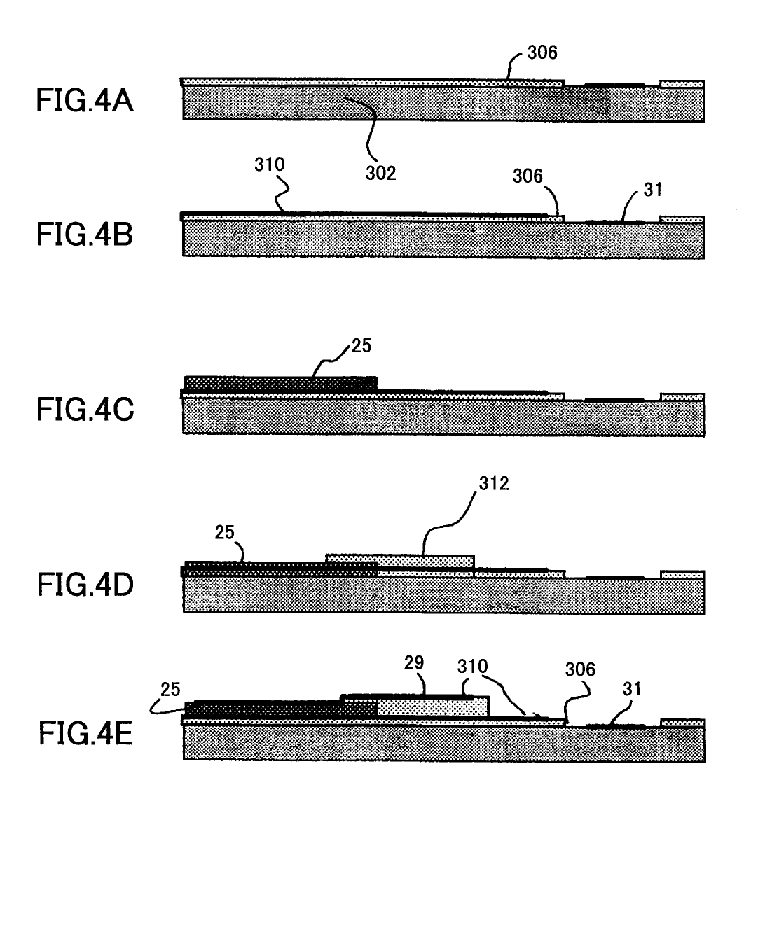

Below, a method of producing an adjustment structure or an adjustment element of the vibrating mirror of the present embodiment are described with reference to FIG. 4A through FIG. 4E.

FIG. 4A through FIG. 4E are cross-sectional view of the vibrating mirror illustrating a method of fabricating an adjustment structure or an adjustment element of the vibrating mirror of the present embodiment.

As shown in FIG. 4A, an adjustment structure 302, which is connected to the torsional beam 2, is single crystal silicon, the torsional beam 2 and the upper frame 4 are formed integrally, and after the thermal oxide film 306 formed on the portion 411 of the upper frame 4 is removed, an electrode pad 308 is formed on the exposed silicon surface by sputtering as described above.

Next, as shown in FIG. 4B, a metal film 310 serving as an electrode is formed, by sputtering, on the back side of the adjustment element, for example, a piezoelectric element, which is arranged on the thermal oxide film 306.

Next, as shown in FIG. 4C, a film used for forming a piezoelectric element 25 is deposited by ion-sputtering or other methods while adjusting compositions of the piezoelectric element 25.

Next, as shown in FIG. 4D, an oxide film 312 is formed by sputtering on the surface of the piezoelectric element 25 to act as an insulating film between electrodes.

Next, as shown in FIG. 4E, a metal film 29 is formed by sputtering using a mask from a surface of the piezoelectric element 25 to a thermal oxide film 312. Then, the adjustment element as shown in FIG. 2A and FIG. 2B are fabricated.

### Second Embodiment

Below, an adjustment structure of the vibrating mirror of a second embodiment of the present invention is primarily described.

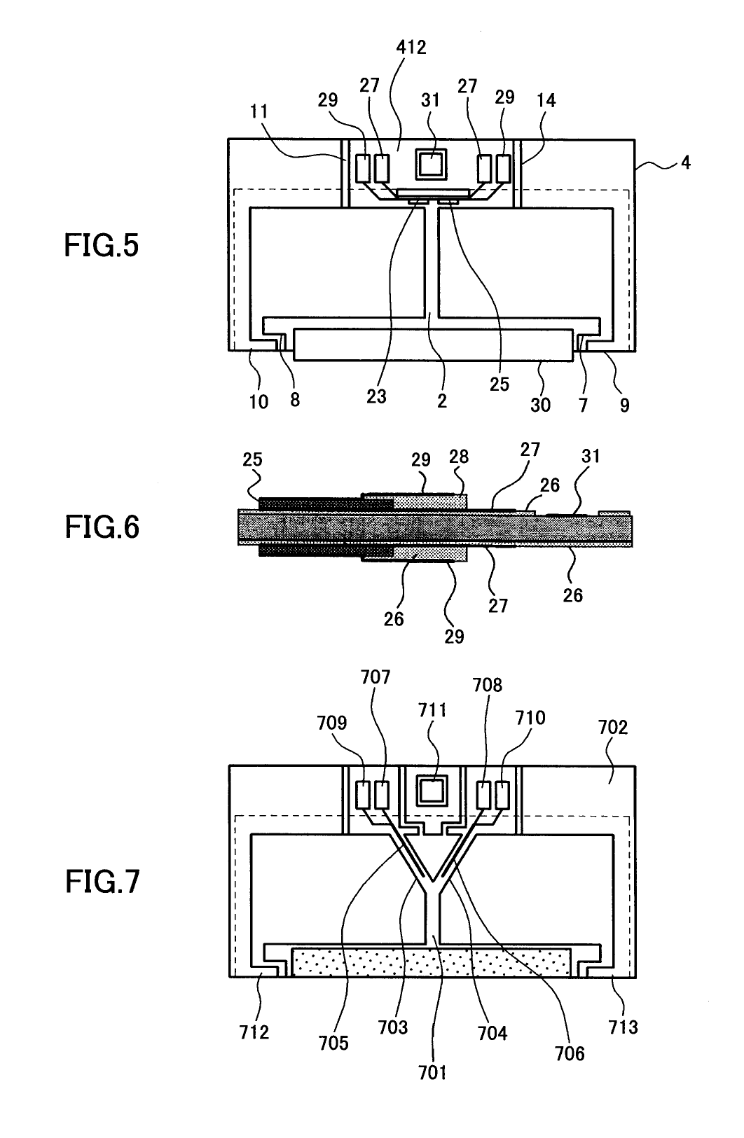

FIG. 5 is a partial plan view illustrating a configuration of a vibrating mirror according to a second embodiment of the present invention.

In the vibrating mirror shown in FIG. 5, similarly, the adjustment structure 23 is formed, by penetrating etching, on a portion of an upper frame 4 integrally to act as a supporting portion of a torsional beam 2. The adjustment structure 23 is designed to have appropriate width and thickness so as not to be influenced by deformation occurring when the torsional beam 2 is vibrated.

An oxide film is deposited on the surfaces of the adjustment structure 23 and the torsional beam 2, and with the oxide film in between, a pair of the piezoelectric elements 25 are arranged on the surface of the adjustment structure 23 at positions (not illustrated) symmetric with respect to the length direction of the adjustment structure 23. The surface of the adjustment structure 23 is divided into regions insulating from each other.

An oxide film is formed on the portion 412 of the upper frame 4 following the adjustment structure 23, and a pair of the electrode pads 27, 29 are disposed on the surface of the oxide film, which electrode pads extend from the top surface and the bottom surface of the piezoelectric element 25, and are insulted from each other by the oxide film.

The oxide film formed on the portion 412 is removed, and the electrode pad 31 is formed on the exposed silicon surface. Here, the structures of the electrode pads are the same as those in FIG. 2A and FIG. 2B, and overlapping explanations are omitted.

When a voltage is applied on the electrode pad 27 and the electrode pad 29, which extend from the top surface and the bottom surface of the pair of piezoelectric elements 25, the piezoelectric element 25 tends to be deformed, accordingly, the internal stress of the adjustment structure 23 changes. When a compressive stress is imposed on the adjustment structure 23, a compressive stress is also imposed on the torsional beam 2, which is joined to the adjustment structure 23; when a tensile stress is imposed on the adjustment structure 23, a tensile stress is imposed on the torsional beam 2. At this moment, since the two piezoelectric elements 25 perform the same operations with the torsional beam 2, the adjustment structure 23 (a control element), which controls each of the two piezoelectric elements 25 independently, has high degree of freedom for control with respect to the torsional deformation during vibration of the torsional beam.

### Third Embodiment

Below, an adjustment structure of the vibrating mirror of the present embodiment is primarily described.

FIG. 6 is a cross-sectional view illustrating a configuration of a vibrating mirror according to a third embodiment of the present invention.

In the vibrating mirror shown in FIG. 6, oxide films 26 are deposited on the top surface and bottom surface of an adjustment structure, an electrode pad 31 is formed in a portion where the oxide film 26 on the top surface is removed, which electrode pad 31 applies a voltage on mirror substrate 1 through the adjustment structure and torsional beams.

The electrode pads 27 are disposed on the oxide film 26 formed on the two surfaces of the adjustment structure, which electrode pads 27 extend from the bottom surfaces of piezoelectric elements 25. Further, oxide films 28 are formed on the two surfaces of the adjustment structure on the extending portions of the electrode pads 27, 31, the electrode pads 29 are disposed on the surfaces of the oxide film 28, which electrode pads 29 extend from the surfaces of piezoelectric elements 25.

If a voltage is applied on the electrode pad 27 and the electrode pad 29, which extend from the piezoelectric element 25 formed on two surfaces of the adjustment structure, the piezoelectric element 25 tends to be deformed, accordingly, the internal stress of the adjustment structure changes. When a compressive stress is imposed on the adjustment structure, a compressive stress is also imposed on the torsional beam 2, which is joined to the adjustment structure; when a tensile stress is imposed on the adjustment structure, a tensile stress is imposed on the torsional beam 2.

In this way, in the present embodiment, since the piezoelectric elements for imposing stress on the torsional beams are arranged to be symmetric relative to the thickness direction of the torsional beam, it is possible to adjust the resonating frequency of the mirror at high resolution.

### Fourth Embodiment

Below, an adjustment structure of the vibrating mirror of the present embodiment is described.

FIG. 7 is a partial plan view illustrating a configuration of a vibrating mirror according to a fourth embodiment of the present invention.

In the vibrating mirror shown in FIG. 7, a torsional beam 701 and two adjustment structures 703, 704 are formed integrally by penetrating etching, as in the previous embodiments. The adjustment structures 703, 704 are parts of an upper frame 702 supporting the torsional beam 701, and the adjustment structures 703, 704 form a Y-shape. The adjustment structures 703, 704 are designed to have appropriate width and thickness so as not to be influenced by deformation occurring when the torsional beam is vibrated.

Note that here, by “frame”, it means a structure supporting the torsional beam, and its shape does not change with the operations of the torsional beam.

An oxide film is deposited on the surfaces of the adjustment structures 703 and 704 and the torsional beam 701, and with the oxide film in between, piezoelectric elements 705, 706 are arranged on the surface of the adjustment structures 703, 704 in the length direction of torsional beam 701 and extending up to the frame 702. The surfaces of the adjustment structures 703, 704 are divided into regions insulating from each other.

An oxide film is formed on the portion of the frame 702 following the adjustment structures 703, 704, and electrode pads 707, 708, 709, 710 are disposed on the surface of the oxide film, which electrode pads extend from the top surface and the bottom surface of the piezoelectric element and are insulted from each other by the oxide film.

The oxide film formed on the portion of the frame 702 is removed, and an electrode pad 711 is directly formed on the exposed silicon surface.

When a voltage is applied on the electrode pad 709, 707 and the electrode pads 710, 708, which extend from the top surfaces and the bottom surfaces of the piezoelectric elements 705, 706, the piezoelectric elements 705, 706 tend to be deformed, accordingly, the internal stress of the adjustment structures 703, 704 changes. When a compressive stress is imposed on the adjustment structures, a compressive stress is also imposed on the torsional beam 701, which is joined to the adjustment structures; when a tensile stress is imposed on the adjustment structures, a tensile stress is also imposed on the torsional beam 701.

Note that in FIG. 7, reference numbers 712, 713 indicate interdigital shape fixed electrodes.

### Fifth Embodiment

Below, a vibrating mirror according to the present embodiment is described. In the present embodiment, a vibrating mirror element is accommodated in a decompression chamber.

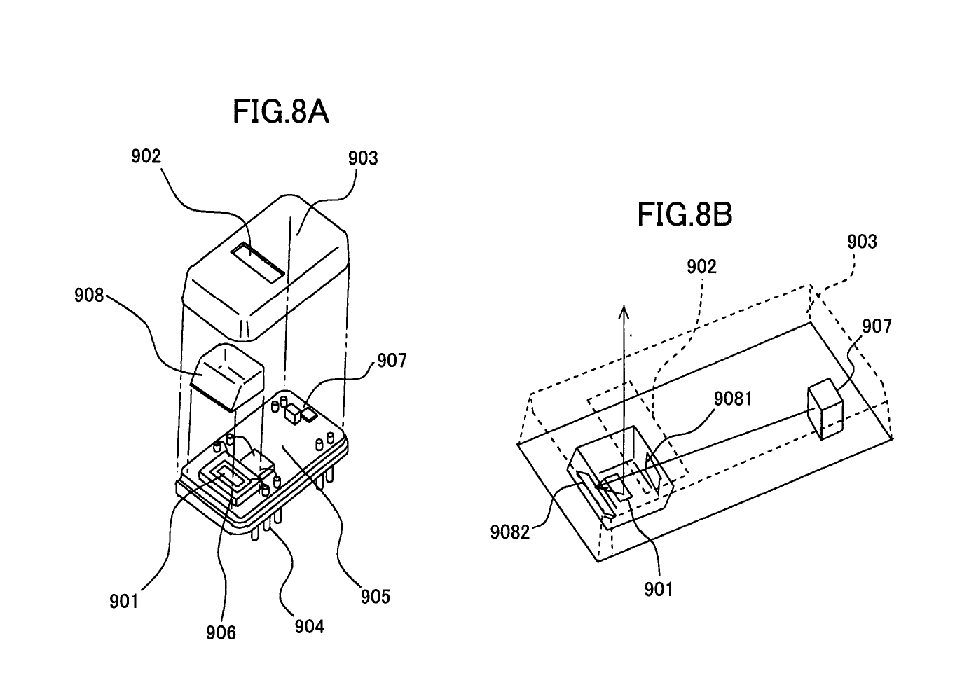

FIG. 8A is an exploded perspective view of a vibrating mirror according to the fifth embodiment of the present invention.

FIG. 8B is a perspective view of the vibrating mirror according to the fifth embodiment of the present invention.

As shown in FIG. 8A and FIG. 8B, the decompression chamber includes a cover 903, and a transmission part 902 is provided on the cover 903 for a light beam deflected by a mirror substrate 901 to pass through. For example, the transmission part 902 is a light beam transmission window. The vibrating mirror of the present embodiment has a mirror device, and terminals 904 are provided in a space 905 for connecting the mirror device and a mirror driving unit, and the cover 903 and the space 905 are sealed so that the device is decompressed. Inside the device, there is a vibrating mirror 906 as described previously, an LD chip 907 acting as a light source, a mirror set 908 for deflecting the light beam from the light source 907 to the mirror substrate 901 of the light scanning device.

As shown in FIG. 8B, the light beam emitted from the LD chip 907 (that is, the light source) enters into an entrance 9081 of the mirror set 908, a mirror 9082 of the mirror set 908 reflects the incident light beam, and the reflected light beam is deflected by a certain vibrating mirror, which is defined by a vibrating-mirror surface of the mirror substrate 901, and the deflected light beam passes through the transmission part 902 on the cover 903 and is emitted out.

### Sixth Embodiment

Below, a light write device according to the present embodiment is described, which includes a light scanning device as described in the fifth embodiment, namely, the light scanning device has a vibrating mirror device as described previously, and the vibrating mirror device is accommodated in a decompression chamber. For example, the light write device is used in an electricphotographic printer, copier, or other electricphotographic image forming apparatus.

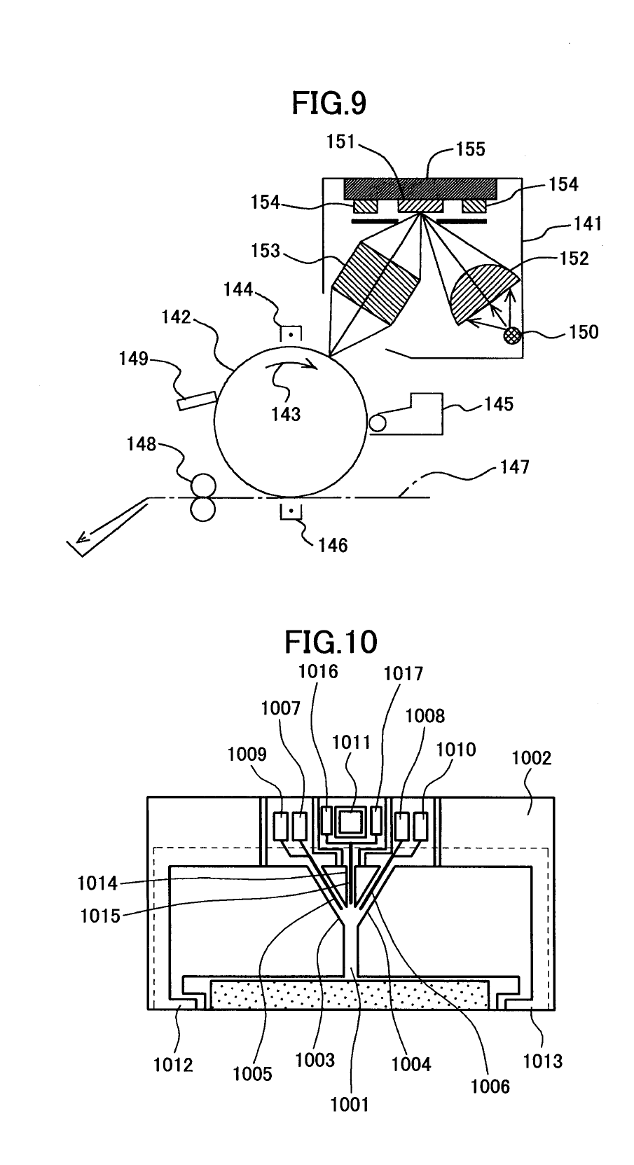

FIG. 9 is a schematic view of an image forming apparatus including a light write device according to a sixth embodiment of the present invention.

As shown in FIG. 9, the image forming apparatus includes a light write device 141, a photoconductive drum 142 providing a scanning surface for the light write device 141, a charging unit 144 for applying charges onto the surface of the photoconductive drum 142, a developing unit 145 for developing electrostatic latent images, a transferring unit 146 for transferring toner images to a recording sheet 147, a fusing unit 148 for fusing the transferred toner images on the recording sheet 147, and a cleaning unit 149 for cleaning residual toner on the surface of the photoconductive drum 142.

Specifically, the light write device 141 emits one or plural laser beams modulated by input image data to scan the scanning surface of the photoconductive drum 142 along an axial direction of the photoconductive drum 142.

The photoconductive drum 142 is driven to rotate along an arrow direction 143, and the charging unit 144 applies charges onto the surface of the photoconductive drum 142, and when the laser beams from the light write device 141 scan the scanning surface of the photoconductive drum 142, electrostatic latent images are formed on the surface of the photoconductive drum 142. The electrostatic latent images are developed by the developing unit 145, and are converted into visible toner images, the toner images are transferred to the recording sheet 147 by the transferring unit 146. The transferred toner images are fused on the recording sheet 147 by the fusing unit 148. Residual toner on the surface of the photoconductive drum 142 passing through the transferring unit 146 is cleaned by the cleaning unit 149.

It should be noted that instead of the photoconductive drum 142, a photoconductive belt may be used. In addition, instead of the above procedure, the toner images may be transferred to a transferring medium first, and then, the toner images are transferred to and fused on the recording sheet 147.

As shown in FIG. 9, the light writing device includes a light source 150 which emits one or plural laser beams modulated by input image data, a vibrating mirror 151, an image forming optical system 152 which condenses the light beams from the light source 150 onto the mirror surface of the mirror substrate of the vibrating mirror 151 to form an image, a scanning optical system 153 which directs the light beams deflected on the mirror substrate of the vibrating mirror 151 onto the scanning surface of the photoconductive drum 142.

The vibrating mirror 151 and an integrated circuit 154 for driving the vibrating mirror 151 are mounted on a circuit board 155, and the structure including the vibrating mirror 151, the integrated circuit 154, and the circuit board 155 are installed in the light writing device.

According to the light writing device of the present embodiment, since the vibrating mirror of the present invention enables stable adjustment of the resonating frequency, and power consumption for driving the vibrating mirror of the present invention is low compared to a light scanning device employing a rotating polygonal mirror, it is possible to reduce the power consumption of an image forming apparatus.

Since the wind roaring noise of the mirror substrate of the vibrating mirror of the present invention is low compared to a rotating polygonal mirror, it is possible to improve the noise level of the image forming apparatus.

Compared to the light scanning device employing a rotating polygonal mirror, the light writing device of the present embodiment just needs a rather small space for installation, and the heat produced by the vibrating mirror of the present invention is also very small, it is possible to easily reduce the size of a light write device, and hence, it is possible to easily reduce the size of an image forming apparatus.

Note that In FIG. 9, illustration of components of the image forming apparatus the same as those in the related art is omitted, for example, these components includes a convey unit for the recording sheet 147, a driving unit for the photoconductive drum 142, a controller for the developing unit 145, the transferring unit 146, and others, a driving system for the light source 150.

In addition, in the vibrating mirror of the present invention, in the interdigital-shape portion between the frame and the vibrating mirror, since a height difference equaling a few μm occurs during fabrication, if a voltage is applied on this portion, vibration can be induced.

### Seventh Embodiment

Below, an adjustment structure of the vibrating mirror of the present embodiment is described.

FIG. 10 is a partial plan view illustrating a configuration of a vibrating mirror according to a seventh embodiment of the present invention.

In the vibrating mirror shown in FIG. 10, a torsional beam 1001 and adjustment structures 1003, 1004, and 1014 are formed integrally by penetrating etching, as in the previous embodiments. The adjustment structures 1003, 1004, 1014 are parts of an upper frame 1002 supporting the torsional beam 1001, and form a tree-shape. The adjustment structures 1003, 1004, and 1014 are designed to have appropriate width and thickness so as not to be influenced by deformation occurring when the torsional beam is vibrated.

An oxide film is deposited on the surfaces of the adjustment structures 1003, 1004, 1014 and the torsional beam 1001, and with the oxide film in between, piezoelectric elements 1005, 1006, and 1015 are arranged on the surface of the adjustment structures 1003, 1004, 1014 in the length direction of torsional beam 1001 and extending up to the frame 1002. The surfaces of the adjustment structures 1003, 1004, 1014 are divided into regions insulating from each other.

An oxide film is formed on the portion of the frame 1002 following the adjustment structures 1003, 1004, 1014, and electrode pads 1007, 1008, 1009, 1010, 1016, 1017 are disposed on the surface of the oxide film, which electrode pads extend from the top surface and the bottom surface of the piezoelectric elements and are insulted from each other by the oxide film.

The oxide film formed on the portion of the frame 1002 is removed, and an electrode pad 1011 is directly formed on the exposed silicon surface.

Note that in FIG. 10, reference numbers 1012, 1013 indicate interdigital shape fixed electrodes.

When a voltage is applied on the electrode pad 1009, 1007, the electrode pads 1010, 1008, and the electrode pads 1016, 1017, which extend from the top surfaces and the bottom surfaces of the piezoelectric elements 1005, 1006, 1015, the piezoelectric elements 1005, 1006, 1015 tend to be deformed, accordingly, the internal stress of the adjustment structures 1003, 1004, 1014 changes. When a compressive stress is imposed on the adjustment structures, a compressive stress is also imposed on the torsional beam 1001, which is joined to the adjustment structures; when a tensile stress is imposed on the adjustment structures, a tensile stress is also imposed on the torsional beam 1001.

### Eighth Embodiment

Below, an adjustment structure of the vibrating mirror of the present embodiment is described.

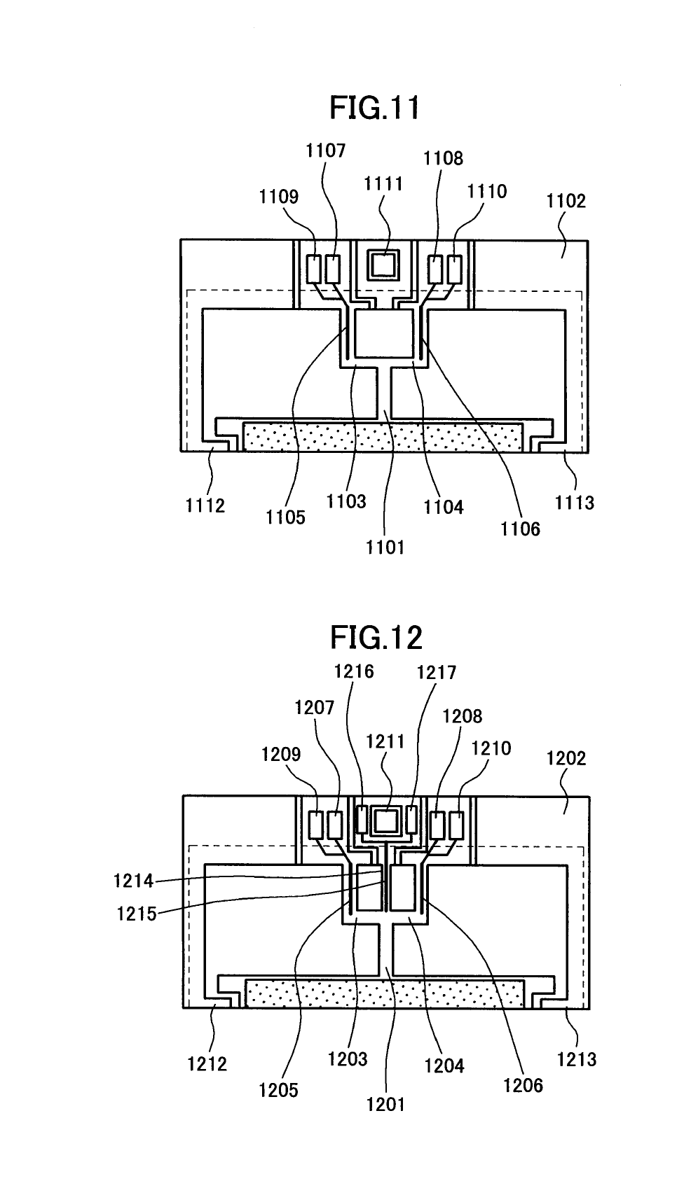

FIG. 11 is a partial plan view illustrating a configuration of a vibrating mirror according to an eighth embodiment of the present invention.

In the vibrating mirror shown in FIG. 11, a torsional beam 1101 and two adjustment structures 1103, 1104 are formed integrally by penetrating etching, as in the previous embodiments. The adjustment structures 1103, 1104 are parts of an upper frame 1102 supporting the torsional beam 1101, and form a square shape. The adjustment structures 1103, 1104 are designed to have appropriate width and thickness so as not to be influenced by deformation occurring when the torsional beam 1101 is vibrated.

An oxide film is deposited on the surfaces of the adjustment structures 1103, 1104 and the torsional beam 1101, and with the oxide film in between, piezoelectric elements 1105, 1106 are arranged on the surface of the adjustment structures 1103, 1104 in the length direction of torsional beam 1101 and extending up to the frame 1102. The surfaces of the adjustment structures 1103, 1104 are divided into regions insulating from each other.

An oxide film is formed on the portion of the frame 1102 following the adjustment structures 1103, 1104, and electrode pads 1107, 1108, 1109, 1110 are disposed on the surface of the oxide film, which electrode pads extend from the top surface and the bottom surface of the piezoelectric elements and are insulted from each other by the oxide film.

The oxide film formed on the portion of the frame 1102 is removed, and an electrode pad 1111 is directly formed on the exposed silicon surface.

When a voltage is applied on the electrode pad 1109, 1107, the electrode pads 1110, 1108, which extend from the top surfaces and the bottom surfaces of the piezoelectric elements 1105, 1106, the piezoelectric elements 1105, 1106 tend to be deformed, accordingly, the internal stress of the adjustment structures 1103, 1104 changes. When a compressive stress is imposed on the adjustment structures, a compressive stress is also imposed on the torsional beam 1101, which is joined to the adjustment structures; when a tensile stress is imposed on the adjustment structures, a tensile stress is also imposed on the torsional beam 1101.

### Ninth Embodiment

Below, an adjustment structure of the vibrating mirror of the present embodiment is described.

FIG. 12 is a partial plan view illustrating a configuration of a vibrating mirror according to a ninth embodiment of the present invention.

In the vibrating mirror shown in FIG. 12, a torsional beam 1201 and adjustment structures 1203, 1204, and 1214 are formed integrally by penetrating etching, as in the previous embodiments. The adjustment structures 1203, 1204, 1214 are parts of an upper frame 1202 supporting the torsional beam 1201, and form a tree-shape. The adjustment structures 1203, 1204, and 1214 are designed to have appropriate width and thickness so as not to be influenced by deformation occurring when the torsional beam is vibrated.

An oxide film is deposited on the surfaces of the adjustment structures 1203, 1204, 1214 and the torsional beam 1201, and with the oxide film in between, piezoelectric elements 1205, 1206, and 1215 are arranged on the surface of the adjustment structures 1203, 1204, 1214 in the length direction of torsional beam 1201 and extending up to the frame 1202. The surfaces of the adjustment structures 1003, 1004, 1014 are divided into regions insulating from each other.

An oxide film is formed on the portion of the frame 1202 following the adjustment structures 1203, 1204, 1214, and electrode pads 1207, 1208, 1209, 1210, 1216, 1217 are disposed on the surface of the oxide film, which electrode pads extend from the top surface and the bottom surface of the piezoelectric elements and are insulted from each other by the oxide film.

The oxide film formed on the portion of the frame 1202 is removed, and an electrode pad 1211 is directly formed on the exposed silicon surface.

Note that in FIG. 12, reference numbers 1212, 1213 indicate interdigital shape fixed electrodes.

When a voltage is applied on the electrode pad 1209, 1207, the electrode pads 1210, 1208, and the electrode pads 1216, 1217, which extend from the top surfaces and the bottom surfaces of the piezoelectric elements 1205, 1206, 1215, the piezoelectric elements 1205, 1206, 1215 tend to be deformed, accordingly, the internal stress of the adjustment structures 1203, 1204, 1214 changes. When a compressive stress is imposed on the adjustment structures, a compressive stress is also imposed on the torsional beam 1201, which is joined to the adjustment structures; when a tensile stress is imposed on the adjustment structures, a tensile stress is also imposed on the torsional beam 1201.

### Other Embodiments

The present invention further includes the following embodiments.

The present invention further provides a light writing device, comprising:

a vibrating mirror that includes

a frame,

a torsional beam,

a mirror substrate supported by the torsional beam and installed inside the frame, said mirror substrate being able to vibrate with the torsional beam as a center axis, wherein the frame, the torsional beam, and the mirror substrate are integrated together; and

an elastic modulus adjustment unit that is arranged in the frame to adjust an elastic modulus of the torsional beam;

a light source driving unit that modulates a light source according to an amplitude of the vibrating mirror; and

an image forming unit that condenses a light beam reflected from a mirror surface of the vibrating mirror to form an image on a scanning surface,

wherein

the vibrating mirror further comprises
a mirror driving unit that drives the mirror substrate;
a transmission part through which a light beam enters the mirror substrate; and
a terminal that is connected to the mirror substrate,

wherein the mirror driving unit, the transmission part, and the terminal are accommodated in a decompression chamber.

In addition, the present invention further provides an image forming apparatus, comprising:

a vibrating mirror that includes
a frame,
a torsional beam,
a mirror substrate supported by the torsional beam and installed inside the frame, said mirror substrate being able to vibrate with the torsional beam as a center axis, wherein the frame, the torsional beam, and the mirror substrate are integrated together; and
an elastic modulus adjustment unit that is arranged in the frame to adjust an elastic modulus of the torsional beam;

an incidence unit that allows a light beam modulated according to a recording signal to be incident on a mirror surface of the vibrating mirror;

an imaging unit that condenses the light beam reflected from the mirror surface of the vibrating mirror to form an image;

an image supporter on which an electrostatic latent image is formed according to the recording signal;

a developing unit that develops the electrostatic latent image by toner; and

a transfer unit that transfers the toner image to a recording sheet,

wherein

the vibrating mirror further comprises
a mirror driving unit that drives the mirror substrate;
a transmission part through which a light beam enters the mirror substrate; and
a terminal that is connected to the mirror substrate,

wherein the mirror driving unit, the transmission part, and the terminal are accommodated in a decompression chamber.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Applications No. 2006-221248 filed on Aug. 14, 2006, and No. 2007-193152 filed on Jul. 25, 2007, the entire contents of which are hereby incorporated by reference.

What is claimed is:

1. A vibrating mirror, comprising:
a frame;
a torsional beam;
a mirror substrate supported by the torsional beam and installed inside the frame so that the mirror substrate is able to vibrate with the torsional beam as a center axis, the frame, the torsional beam, and the mirror substrate being integrated together; and
an elastic modulus adjustment unit that is arranged in the frame to adjust an elastic modulus of the torsional beam.

2. A vibrating mirror, comprising:
a frame;
a torsional beam;
a mirror substrate supported by the torsional beam and installed inside the frame so that the mirror substrate is able to vibrate with the torsional beam as a center axis, the frame, the torsional beam, and said mirror substrate being integrated together; and
an elastic modulus adjustment unit that is arranged in the frame to adjust an elastic modulus of the torsional beam,
wherein
the frame supports the torsional beam and is integrated with the torsional beam through a slit, and
the elastic modulus adjustment unit is able to change an internal stress in the frame.

3. The vibrating mirror as claimed in claim 1, wherein the elastic modulus adjustment unit is arranged to be symmetric with respect to the mirror substrate.

4. The vibrating mirror as claimed in claim 1, wherein a plurality of the elastic modulus adjustment units are arranged at positions symmetric with respect to the torsional beam.

5. The vibrating mirror as claimed in claim 1, wherein a plurality of the elastic modulus adjustment units are arranged at two or more positions symmetric with respect to a thickness direction of the mirror substrate.

6. The vibrating mirror as claimed in claim 1, wherein the mirror substrate, the torsional beam, the frame, and the elastic modulus adjustment unit are formed from silicon and are integrated together.

7. The vibrating mirror as claimed in claim 1, further comprising:
a resonating frequency detection unit that controls the elastic modulus adjustment unit so that a resonating frequency is constant.

8. A vibrating mirror, comprising:
a frame;
a torsional beam;
a mirror substrate supported by the torsional beam and installed inside the frame so that the mirror substrate is able to vibrate with the torsional beam as a center axis, the frame, the torsional beam, and said mirror substrate being integrated together;
an elastic modulus adjustment unit that is arranged in the frame to adjust an elastic modulus of the torsional beam,
a mirror driving unit that drives the mirror substrate;
a transmission part through which a light beam enters the mirror substrate; and
a terminal that is connected to the mirror substrate,
wherein
the mirror driving unit, the transmission part, and the terminal are accommodated in a decompression chamber.

9. The vibrating mirror as claimed in claim 8, wherein
the elastic modulus adjustment unit comprises an adjustment structure, and
the adjustment structure is a Y-like shape, a square, or includes two squares placed side by side, or has an antenna shape.
